(19) United States
(12) Patent Application Publication
(10) Pub. No.: US 2025/0250653 A1
(43) Pub. Date: Aug. 7, 2025

(54) MITIGATION OF CONTAMINATION OF LITHIUM SELECTIVE MEDIA IN A DIRECT LITHIUM EXTRACTION PROCESS

(71) Applicant: Koch Technology Solutions, LLC, Wichita, KS (US)

(72) Inventors: Daniel Travis Shay, Chadds Ford, PA (US); Constantine Collias, Ontario (CA); Jason Alan Bootsma, Wichita, KS (US); Timothy Jude Campbell, Ridley Park, PA (US)

(73) Assignee: Koch Technology Solutions, LLC, Wichita, KS (US)

(21) Appl. No.: 19/041,369

(22) Filed: Jan. 30, 2025

Related U.S. Application Data
(60) Provisional application No. 63/548,870, filed on Feb. 2, 2024.

(51) Int. Cl. C22B 3/22; C22B 3/42; C22B 26/12

(52) U.S. Cl. CPC C22B 3/22; C22B 3/42; C22B 26/12

(57) ABSTRACT

There is disclosed a method for treatment of an aqueous lithium salt-containing solution in a direct lithium extraction process comprising lithium-selective media, wherein the aqueous lithium salt-containing solution comprises one or more foulants, the method comprising the steps of adjusting the oxidative-reductive potential and/or pH of the aqueous lithium salt-containing solution to render the one or more foulants inert to the lithium-selective media; and removing the one or more inert foulants from the aqueous lithium salt-containing solution prior to addition of the aqueous lithium salt-containing solution to the lithium-selective media in a direct lithium extraction process.

### TECHNICAL FIELD

The disclosed method relates to mitigation of contamination of lithium selective media through control of the oxidative-reductive potential and/or the pH of an aqueous lithium salt-containing solution before addition to the lithium selective media in a direct lithium extraction process.

### BACKGROUND

Traditionally, hard rock and evaporative pond mining have been two predominant means for sourcing lithium salts. With an anticipated growth in the global lithium market to meet the increasing demands of lithium-ion batteries for electric vehicles, there is great interest in the current development of direct lithium extraction (“DLE”) methods which show promise for reducing the cost and environmental impact of lithium mining. The main stages of a DLE process include extraction of the lithium from an aqueous lithium salt-containing solution using a lithium selective medium and subsequent elution of the lithium from this lithium selective medium with an eluant to produce an eluate stream, followed by further concentration and purification steps.

The aqueous lithium salt-containing solutions used in DLE methods are typically derived from underground brines or reservoirs in aquifers. Such aqueous lithium salt-containing solutions contain other dissolved or suspended mineral components such as silica, iron, strontium, calcium, magnesium, sodium, calcium, boron, chloride, sulfate and carbonate and sulfate, all of which may represent foulants to the lithium-selective sorbent in the DLE process. The oxidative-reductive potential (“ORP”) of these mineral components (or foulants) can vary during physical processing of the aqueous lithium salt-containing solutions, causing instability of the aqueous lithium salt-containing solutions and formation of unwanted insoluble precipitates which can contaminate the lithium selective medium. Such contamination increases the differential pressure across the lithium selective medium, for example the adsorbent bed, thereby blocking access to active sites for lithium adsorption in the lithium selective sorbent. This causes poor rates of uptake of lithium by the lithium selective sorbent, and consequently, there is a need for a process to prevent or at least mitigate contamination of lithium selective media by foulants.

### SUMMARY

In a first aspect herein, there is provided a method for treatment of an aqueous lithium salt-containing solution in a direct lithium extraction process comprising lithium-selective media, wherein the aqueous lithium salt-containing solution comprises one or more foulants, the method comprising the following steps:
a) adjusting the oxidative-reductive potential and/or pH of the aqueous lithium salt-containing solution to render the one or more foulants inert to the lithium-selective media; and
b) removing the one or more inert foulants from the aqueous lithium salt-containing solution prior to addition of the aqueous lithium salt-containing solution to the lithium-selective media in a direct lithium extraction process.

In an embodiment, the aqueous lithium salt-containing solution is a naturally occurring solution, a synthetic solution, a leachate or a mixture thereof.

In an embodiment, the lithium-selective media is ion-exchange media or lithium-adsorbent media.

In an embodiment, the one or more foulants is of an inorganic, organic, organometallic, ionic or elemental nature.

In an embodiment, the one or more foulants comprises any of silica, iron, strontium, calcium, magnesium, sodium, calcium, boron, chloride, sulfate and carbonate.

In an embodiment, the step of adjusting the oxidative-reductive potential and/or pH of the aqueous lithium salt-containing solution to render the one or more foulants inert comprises increasing the oxidative-reductive potential by air sparging, addition of an oxidant or an electro-chemical modification.

In an embodiment, the oxidant comprises hydrogen peroxide, ozone, sodium hypochlorite, potassium monopersulfate, hypochlorous acid or a hydroxy radical.

In an embodiment, the step of adjusting the oxidative-reductive potential and/or pH of the aqueous lithium salt-containing solution to render the one or more foulants inert comprises decreasing the oxidative-reductive potential by addition of formic acid or metal hydride.

In an embodiment, the step of adjusting the oxidative-reductive potential and/or pH of the aqueous lithium salt-containing solution to render the one or more foulants inert comprises precipitation or decomposition of the one or more foulants.

In an embodiment, the step of removing the one or more inert foulants from the aqueous lithium salt-containing solution prior to addition of the aqueous lithium salt-containing solution to the lithium-selective media in a direct lithium extraction process comprises filtration of the one or more inert foulants.

In an embodiment, the filtration comprises magnetism, membrane separation, multi-media filter, coalescing filter, decanting and/or a guard bed.

In an embodiment, the method further comprises an initial step preceding the step of adjusting the oxidative-reductive potential and/or pH of the aqueous lithium salt-containing solution of monitoring the oxidative-reductive potential and/or pH of the aqueous lithium salt-containing solution.

In an embodiment, the method further comprises an additional initial step of passing the aqueous lithium salt-containing solution through a guard bed.

In an embodiment, the guard bed comprises an adsorbent material capable of adsorption of any unwanted foulant whilst allowing lithium salt to pass through.

In an embodiment, the adsorbent material in the guard bed is an ion exchange resin, a metal oxide or a zeolite, in any of a granular composition, a powder or a slurry.

In an embodiment, the method further comprises an additional step of fluidization of the lithium-selective media and/or the adsorbent material in the guard bed.

In an embodiment, the method further comprises an additional step of addition of a chelating agent to the lithium-selective media in a direct lithium extraction process, wherein the chelating agent is capable of binding to any of the one or more foulants.

In an embodiment, the chelating agent is any of ethylenediaminetetraacetic acid (EDTA), citric acid, oxalic acid or acetic acid.

In an embodiment, the chelating agent is subsequently removed from the lithium-selective sorbent by filtering, rejection or fluidization.

In a second aspect herein, there is provided a method for improving the operability of a direct lithium extraction system comprising lithium-selective media comprising the steps of:
(a) flowing an aqueous lithium salt-containing solution having one or more foulants through the lithium-selective media to remove lithium chloride from the aqueous lithium salt-containing solution;
(b) flowing a desorbent fluid through the lithium-selective media to desorb lithium chloride from the saturated sorbent;
(c) recovering a lithium product stream from the eluate stream; and
(d) operating a procedure for removing at least one of the one or more foulants from the lithium-selective media with a chelating agent capable of binding to the one or more foulants.

In an embodiment, the chelating agent is any of ethylenediaminetetraacetic acid (EDTA), citric acid, oxalic acid or acetic acid.

In an embodiment, after step (d) in which the chelating agent binds to the one or more foulants, the chelating agent is removed from the direct lithium extraction system by filtering, rejection or fluidization.

In an embodiment, the method further comprises the step of flowing the aqueous lithium salt-containing solution through a guard bed prior to flowing the aqueous lithium salt-containing solution through the lithium-selective media.

Other features and aspects of the disclosure are set forth in greater detail below.

### BRIEF DESCRIPTION OF THE DRAWINGS

FIG. 1 is a flowchart depicting the present invention.

FIGS. 2A and 2B show brine in its received state and brine post ORP-adjustment and filtration.

FIG. 3 is a flowchart depicting an alternative embodiment of the present invention.

### DETAILED DESCRIPTION

Unless otherwise defined, all scientific and technical terms used herein are intended to have the same meaning as would be understood by a person of skill in the art to which this disclosure relates. The materials, methods and examples are illustrative only and not intended to be limiting. The word “comprise” and variations such as “comprises” or “comprising” are understood to mean the inclusion of a stated integer or group of integers but not the exclusion of any other integer or group of integers.

Unless specifically stated otherwise or obvious from the context used herein, the terms “about” and “approximately” are understood as lying within a range of normal tolerances in the art, for example within two standard deviations of the mean. “About” and “approximately” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The disclosure is directed to a process for treatment of an aqueous lithium salt-containing solution during a direct lithium extraction (DLE) process. The main stages of a DLE process include extraction of the lithium from an aqueous lithium salt-containing solution using a lithium-selective medium, for example an adsorbent material or an ion-exchange resin and subsequent elution of the lithium from the lithium-selective medium with an eluant to produce an eluate steam, followed by further concentration and purification steps. The eluate is typically at a higher lithium concentration and lower impurity level than the original aqueous lithium salt-containing solution. The spent aqueous lithium salt-containing solution may be reinjected back into the original source aquifers or alternative geological formations. The process as disclosed herein is directed to a method of treatment of the aqueous lithium salt-containing solution, typically before the aqueous lithium salt-containing solution is added to the DLE process. The method discloses intentional control of the oxidative-reductive potential (ORP) and/or pH of the aqueous lithium salt-containing solution before introduction to the lithium-selective media, to prevent or at least minimize contamination of the lithium-selective media, and thereby allow complete removal of lithium by the lithium-selective media in the direct lithium extraction process.

In particular, the disclosure is directed to a method for treatment of an aqueous lithium salt-containing solution in a direct lithium extraction process comprising lithium-selective media, wherein the aqueous lithium salt-containing solution comprises one or more foulants, the method comprising the following steps:
a) adjusting the oxidative-reductive potential and/or pH of the aqueous lithium salt-containing solution to render the one or more foulants inert to the lithium-selective media; and
b) removing the one or more inert foulants from the aqueous lithium salt-containing solution prior to addition of the aqueous lithium salt-containing solution to the lithium-selective media in a direct lithium extraction process.

The source of the aqueous lithium salt-containing solution is not limited by the disclosure but may originate from a variety of sources such as any of a geothermal source, oil fields, hard rock lithium mining, aquifers, mineral digestion, tailings from a lithium mining process, a well application, a clay, a leachate or sea water. In another embodiment the aqueous lithium salt-containing solution is produced synthetically by extraction from a lithium containing material and may be, for example, any aqueous recycling solution containing lithium chloride. Examples of lithium containing materials include clays, black mass, off-specification battery materials, recycled battery materials or combinations of these materials; the resulting extractant in these examples comprises acidity and cations. Examples of components of the extractant are hydrochloric acid, sodium chloride, potassium chloride, perchloric acid and chloric acid. The extractant is then pH adjusted to the desired range for a specific sorbent. The aqueous lithium salt-containing solution may therefore be a naturally occurring solution, a leachate, a synthetic solution, or a combination thereof. The lithium may be considered to be a brine and may be present in the aqueous lithium-containing solution as, for example, lithium chloride.

The aqueous lithium salt-containing solution is introduced to a direct lithium extraction process which comprises a processing system having an adsorbent medium and/or an ion exchange resin for selectively extracting lithium cations from the aqueous lithium salt-containing solution. The adsorbent medium and/or an ion exchange resin are selective to lithium cations and allow lithium cations to be selectively extracted from the aqueous lithium salt-containing solution.

The specific nature of the lithium-selective adsorbent is not limited by the disclosure but may be any of an ion sieve adsorbent, a lithium-metal oxide adsorbent, a mixed metal oxide adsorbent, an alkali or alkali earth metal/alumina matrix, transition metal/alumina matrix or a molecular sieve adsorbent. In one embodiment, the lithium-selective adsorbent may be a layered aluminum double hydroxide chloride sorbent (LiCl·Al2(OH)6·nH2O) which has a high selectivity to lithium. The lithium-selective sorbent can allow for the extraction or recovery of a relatively high amount of lithium from the aqueous lithium-containing solution. For instance, the amount of lithium adsorbed from the aqueous lithium-containing solution may be 20 mol % or more, such as 30 mol % or more, such as 40 mol % or more, such as 50 mol % or more, such as 60 mol % or more, such as 70 mol % or more, such as 80 mol % or more, such as 90 mol % or more, such as 95 mol % or more based on the total amount of lithium present in the aqueous lithium-containing solution. It should be understood that such amount may be based on the total amount of lithium present in the aqueous lithium-containing solution that is provided to the lithium-selective sorbent. In this regard, the aqueous lithium-containing solution containing lithium may be converted to a barren brine. The barren aqueous lithium-containing solution may be returned to the source from which it was originally obtained or an alternative geological formation.

The ion exchange resin may comprise ion exchange particles, the material of which may, for example, include insoluble polymers containing a backbone of cross-linked polystyrene and side chains of ion-active groups.

The lithium-selective media may be contained in the direct lithium extraction process in one or more columns which may be packed-bed or free-loading columns, arranged either in series or parallel, and/or in beds such as simulated moving beds.

Each aqueous lithium salt-containing solution has its own oxidative-reductive potential, also known as oxidoreduction potential, oxidation-reduction potential and redox potential, which is a measure of the tendency of a solution to either gain or lose electrons in a reaction. A solution with a higher (more positive) ORP compared to another molecule will have a tendency to gain electrons from this molecule (i.e. to be reduced by oxidizing this other molecule) and a solution with a lower (more negative) ORP will have a tendency to lose electrons to other molecules. ORP is therefore the direct measurement of electrons in transit during oxidation-reduction reactions.

As an aqueous lithium salt-containing solution is flowed from its source to a DLE processing plant via a series of pipes, tubing and vessels, the aqueous lithium salt-containing solution is exposed to oxygen and undergoes modifications to its oxidative-reductive potential. Aqueous lithium salt-containing solutions from different sources contain different types of oxidizing and reducing components, for example, iron, strontium, calcium, magnesium, sodium, calcium, boron, chloride, sulfate and carbonate, each capable of existing in different potential states. These components may exist in alternative states, for example, in any of an inorganic, organic, organometallic, ionic or elemental state.

These different components may represent foulants. Foulants are any unwanted components to the direct lithium extraction process which may detrimentally affect the performance of the lithium-selective media, purity of the final lithium product from the DLE process and the performance of downstream lithium processing steps, including the steps required to convert lithium chloride to lithium carbonate. Lithium purity is a measure of the lithium against all other non-volatile components in the solution such as silica, iron, strontium, calcium, magnesium, sodium, calcium, boron, chloride, sulfate and carbonate, as previously mentioned (i.e. not water or volatile solvents). The nonvolatile components, or potential foulants, are often measured or expressed collectively as Total Dissolved Solids (TDS) and may include any of iron, strontium, calcium, magnesium, sodium, calcium, boron, chloride, sulfate and carbonate, although the foulants are not limited by the disclosure.

The oxidative-reductive potential can also be intentionally modified, and this can have the effect of rendering inert any of the components in the aqueous lithium salt-containing solutions which exist in any of an inorganic, organic, organometallic, ionic or elemental state.

The pH also closely follows the oxidative-reductive potential and in addition to, or instead of the oxidative-reductive potential, the pH can also be intentionally modified. For instance, the pH adjustment may be provided by using a pH adjustment solution. In this regard, the pH adjustment solutions are not necessarily limited by the disclosure and may be one generally utilized in the art for adjusting pH. This pH adjustment solution may, depending on the desired direction of the pH adjustment, include an acid or a base.

The oxidative-reductive potential, and/or pH, can be adjusted so as to be higher or lower than the original oxidative-reductive potential, and/or pH. The oxidative-reductive potential, and/or pH, can be increased by air sparging, addition of an oxidant or an electro-chemical modification. The oxidant may be any substance capable of increasing the ORP of a solution, and may be, for example, any of hydrogen peroxide, ozone, sodium hypochlorite, potassium monopersulfate, hypochlorous acid, a hydroxy radical or any other suitable compound capable of increasing oxidative-reductive potential.

The oxidative-reductive potential, and/or pH, can be decreased by addition of formic acid, metal hydride or any other suitable compound capable of decreasing oxidative-reductive potential.

Adjustment of the ORP and/or pH, so as to be either higher or lower than the original oxidative-reductive potential and/or pH, causes the foulant to be altered in some form, and thereby become inert. Becoming “inert” as herein referenced includes being subject to phase separation, being broken down into constituents, being decomposed, becoming inactive, being precipitated, coagulated or flocculated.

Once the one or more foulants has become inert, the one or more foulants is removed from the aqueous lithium salt-containing solution. Removal can include either partial or complete removal of the one or more foulants from the aqueous lithium salt-containing solution. Removal may be, for example, by a method of filtration, which can include magnetism, membrane separation, a multi-media filter, an electro-membrane process such as electrodialysis and/or a guard bed. The filtration may also include multi-media depth filtration, membrane micro-filtration, membrane ultra-filtration, as well as other methods generally utilized in the art.

Measurement of the ORP of an aqueous lithium salt-containing solution, such as a brine, is typically in millivolts (mV), and positive numerical values represent oxidizing conditions whilst negative numerical values represent reducing conditions. ORP sensors are widely available and are currently used to analyze groundwater in aquifer systems and to monitor wastewater in treatment facilities and sewer systems, where ORP is a measurement of the ability of wastewater to permit the occurrence of specific biological (oxidation-reduction) reactions. Under oxidizing conditions, the measuring probe of the ORP sensor loses electrons to the solution, thereby creating a positive potential and in a reducing environment, electrons are donated to the probe of the ORP sensor, producing a negative potential. Since a reducing agent is capable of accepting an electron and an oxidizing agent is capable of donating an electron or accepting a proton, it can be said that the stronger the reducing agent the more negative the ORP value, and the stronger the oxidizing agent the more positive the ORP value. The present disclosure may also comprise an initial step of monitoring the oxidative-reductive potential and/or pH of the aqueous lithium salt-containing solution before the step of adjusting the oxidative-reductive potential and/or pH of the aqueous lithium salt-containing solution to render the one or more foulants inert to the lithium-selective sorbent. In one embodiment, the monitoring may be performed using an ORP sensor. An advantage of monitoring the oxidative-reductive potential and/or pH of the aqueous lithium salt-containing solution before the step of adjusting the oxidative-reductive potential and/or pH of the aqueous lithium salt-containing solution is that the oxidative-reductive potential can be either increased or decreased more precisely to render the one or more foulants inert and thereby be removed.

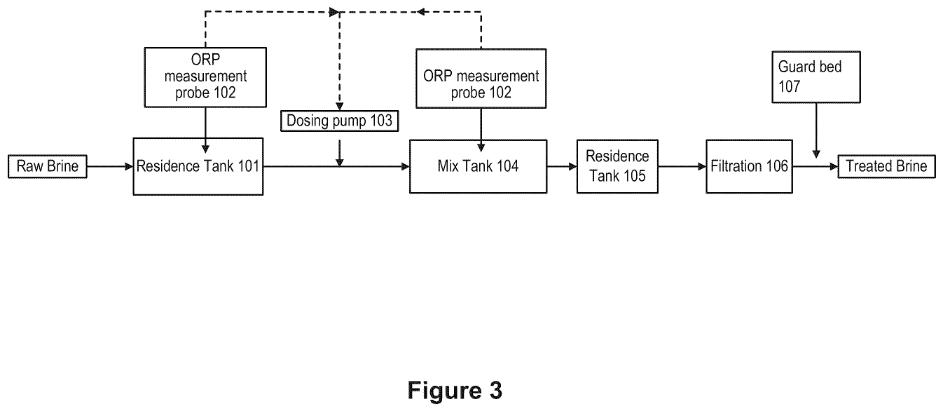

The present disclosure may also comprise an additional initial step of passing the aqueous lithium salt-containing solution through a guard bed, as shown in FIG. 3. The guard bed is located upstream of the DLE process and comprises an adsorbent material capable of adsorption of any unwanted foulant whilst allowing lithium salt to pass through. Such adsorbent material may be a granular composition, a powder or a slurry, for example, an ion exchange resin, a metal oxide, activated alumina, activated carbon or a zeolite. This step of using a guard bed can be added before the step of adjusting the oxidative-reductive potential and/or pH of the aqueous lithium salt-containing solution to render the one or more foulants inert to the lithium-selective sorbent.

The present disclosure may also comprise an additional initial step of loosening, fluffing or fluidizing the one or more columns of lithium-selective media and/or the adsorbent material in the guard bed. This step involves reversing the flow of fluid and serves to loosen the lithium-selective media, which can become compacted over time with the flow of the aqueous lithium salt-containing solution.

On some occasions, the lithium-selective sorbent may become contaminated or polluted with any of one or more foulants, and on such occasions, it is preferable to clean the adsorbent material whilst it is in the column, rather than removing the adsorbent material from the column, as this “clean-in-place” procedure saves downtime and reduces the overall operation cost of the process. The additional step of cleaning any contaminated media is performed by adding a chelating agent to the adsorbent material. The chelating agent is capable of binding to any of the foulants and may be any of ethylenediaminetetraacetic acid (EDTA), citric acid, oxalic acid or acetic acid. Once the chelating agent has bound to the foulant, either partially or fully, the chelating agent is subsequently removed from the lithium-selective sorbent by filtering, rejection or fluidization, as well as other methods generally utilized in the art.

The processes of the disclosure will now be more particularly described with reference to the following non-limiting Examples.

### EXAMPLES

### Example 1: Removal of Iron from Raw Brine Using an ORP Dosing Circuit

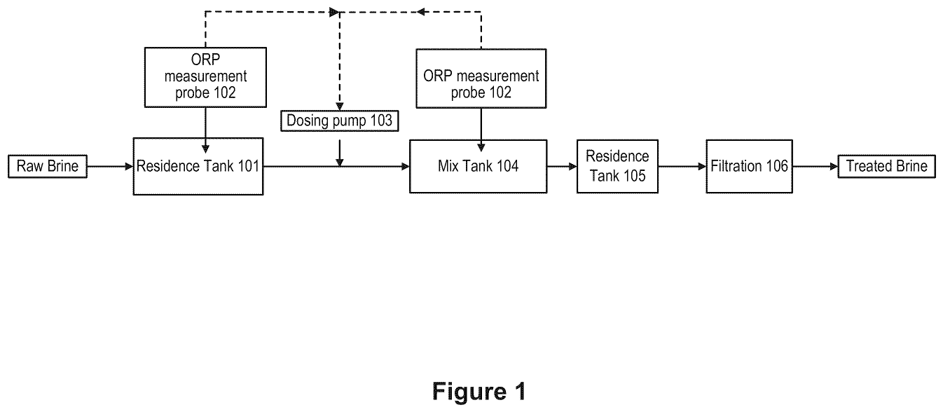

With reference to FIG. 1, raw brine was pumped from the Smackover formation and the hydrogen sulphide was stripped at the well head. The brine temperature was adjusted so as to be below 60° C. using a cooling tower. The brine was then introduced into a residence tank 101 where the ORP was measured with a probe 102. This measurement was fed to a PLC that controlled a hydrogen peroxide dosing pump 103. The dosing pump added a 30% hydrogen peroxide solution to the process line of flowing brine. The brine that had been dosed with hydrogen peroxide was collected in a mix tank 104 where the ORP measurement was verified. The targeted OPR level was 300 mV for this run. The brine was sent from the mix tank to a secondary residence tank 105 that allowed the brine to age for 3 to 5 hours. The aged brine was then filtered with a Puron MP UF filtration system 106 from Kovalus Separation Solutions. This filter had a nominal filtration of 0.03 microns. The filtered brine was treated and introduced to the DLE process.

Table 1 shows the iron content of the brine without and with the ORP adjustment according to the present invention. Clearly, the process of adjusting the ORP lowers the iron content of the brine.

TABLE 1

| | | Iron (Fe) |
|---|---|---|
| | Location | content (mg/L) |
| Without ORP adjustment | Raw brine | 1.2 |
| With ORP adjustment | Post dosing pump 103 | 0.2 |
| With ORP adjustment | Treated brine | 0.09 |

### Example 2: Iron Precipitation Through Chemical Adjustment

Based on a pH-ORP chart for iron, the target condition chosen was a pH of 6.5 and an ORP of +500 mV. The aim was to ensure that iron was converted to Fe(III) via the ORP adjustment and would precipitate as Fe(III)OH₃ after the pH adjustment.

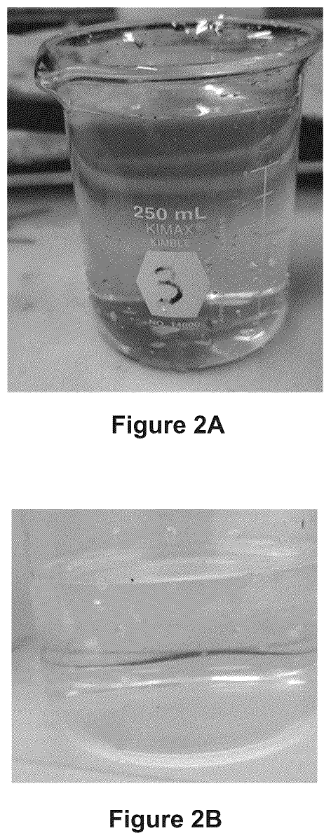

FIG. 2A shows the brine in its as received state, with a measured value of 21 mg/L of dissolved iron and approximately 60 mg/L of suspended solids, some of which was assumed to be iron due to colouration. The brine condition was in a pH range of 5.7-5.8.

1N sodium hydroxide (NaOH) was used to perform the pH adjustment in this example, and a solution of 30% hydrogen peroxide was used to adjust the ORP. Once the treatment was done and the solution mixed, the solution was filtered by traditional means (pore size filtration technique, 1 micron cartridge filter).

FIG. 2B shows the brine post-filtration. The brine had a dissolved iron content below 1 mg/L and was ready for use with the DLE process.

Example 2 clearly demonstrates that ORP and pH adjustments cause precipitation of iron, which can be removed from the brine before use in a DLE process.

### Example 3: Cleaning of Fouled Media to Recover Li Capacity

a) 50 mL batch test for fouled media cleaning.

Commercial operated fouled media: 10 g of commercial operated fouled media was placed in a 50 mL test tube. 40 mL of pH adjusted chelating agent (0.001 M 2 Na EDTA, 0.001 M 4 Na EDTA or 0.001 M 2 DTPA) was added to the test tube. The test tube was capped and placed on an orbital mixer for 4 hours. After mixing the liquid was decanted and analyzed by inductively coupled plasma-optical emission spectrometry (ICP-OES) while the media was kept in the test tube. The fouled media in the 50 mL test tube was treated a second time in the same way with the addition of 40 mL of pH adjusted chelating agent and 4 hours of orbital mixing. The solution was decanted again and tested via ICP-OES.

Fouled media standard: A fouled media standard was created by placing 10 g of commercially fouled media in a 50 mL test tube. 40 mL of deionized water was added to the test tube, which was capped and mixed on an orbital mixer for 4 hours. After mixing the liquid was decanted, the media was kept in the test tube while all the solution removed and tested on an ICP OES to determine metals that were removed in the liquid sample. The fouled media in the 50 mL test tube was rinsed a second time with the addition 40 mL of deionized water and 4 hours of orbital mixing. The solution was decanted and tested via ICP OES.

Clean conditioned media standard: A clean media standard was created by placing 10 g of conditioned, operational media in a 50 mL test tube. 40 mL of deionized water was added to the test tube, which was capped and mixed on an orbital mixer for 4 hours. After mixing the liquid was decanted, the media was kept in the test tube while all the solution removed and tested on an ICP OES to determine metals that were removed in the liquid sample. The clean media in the 50 mL test tube was rinsed a second time with the addition 40 mL of deionized water and 4 hours of orbital mixing. The solution was decanted and tested via ICP OES.

TABLE 3A

| | Al | Fe | Li | Mg | Na | Ca |
|---|---|---|---|---|---|---|
| Conditions | (ppm) | (ppm) | (ppm) | (ppm) | (ppm) | (ppm) |
| Commercial operated | 0.33 | 5.21 | 86.67 | 26.48 | 11921 | −10.4 |
| fouled media (0.001M | | | | | | |
| 2 Na EDTA | | | | | | |
| treatment) | | | | | | |
| Commercial operated | 0.4 | 6.66 | 82.29 | 22.42 | 11994 | −20.2 |
| fouled media (0.001M | | | | | | |
| 4 Na EDTA | | | | | | |
| treatment) | | | | | | |
| Commercial operated | 0.32 | 5.86 | 86.68 | 25.27 | 11955 | −11.4 |
| fouled media (0.001M | | | | | | |
| 2 DTPA treatment) | | | | | | |
| Fouled media standard | 0.57 | 4.92 | 53.41 | 592.67 | 31083 | 329 |
| (eluted) | | | | | | |
| Clean conditioned | 1.41 | −1.82 | 11.41 | 626.24 | 26943 | 241 |
| media standard | | | | | | |
| (eluted) | | | | | | |

TABLE 3B

| | Al | Fe | Li | Mg | Na | Ca |
|---|---|---|---|---|---|---|
| | (ppm) | (ppm) | (ppm) | (ppm) | (ppm) | (ppm) |
| Commercial | 0.55 | 13.58 | 118.33 | 16.97 | 9204 | 1.21 |
| operated fouled | | | | | | |
| media (0.001M 2 | | | | | | |
| Na EDTA | | | | | | |
| treatment 2nd | | | | | | |
| time) | | | | | | |
| Commercial | 0.52 | 9.16 | 109.7 | 14.14 | 9280 | 1.2 |
| operated fouled | | | | | | |
| media (0.001M 4 | | | | | | |
| Na EDTA | | | | | | |
| treatment 2nd | | | | | | |
| time) | | | | | | |
| Commercial | 1.69 | 57.94 | 117.75 | 15.26 | 9242 | 1.28 |
| operated fouled | | | | | | |
| media (0.001M 2 | | | | | | |
| DTPA treatment | | | | | | |
| 2nd time) | | | | | | |
| Fouled media | 0.46 | 7.85 | 99.46 | 168.67 | 11612 | 7.21 |
| standard (water | | | | | | |
| rinsed 2x) | | | | | | |
| Clean conditioned | 3.89 | −1.80 | 32.67 | 138.71 | 10852 | 5.13 |
| media standard | | | | | | |
| (water rinsed 2x) | | | | | | |

As shown in Tables 3A and 3B, the larger increase in iron concentration and small increase of aluminum concentration in the commercial operated fouled media liquid samples after two washes shows that the treatments effectively cleaning this fouled media. Comparatively, the fouled media standard sample has released minimal iron concentration, and the clean conditioned media has released none. In Table 3B, the Li, Mg, Na and Ca all just show the similarity of brine feeds.

### b) 50 mL Batch Adsorbent Test to Evaluate Fouled Media Cleaning.

The 50 mL batch adsorbent test to evaluate fouled media treatment was performed by placing 10 g of treated commercial fouled media in a 50 mL test tube. 40 mL of standard feed brine was added to the test tube. The standard feed brine contained ˜110 ppm lithium, 725 ppm magnesium, 1635 ppm calcium and 41000 ppm sodium. The test tube was capped and placed on an orbital mixer for 4 hours. After mixing the liquid was decanted, the media was kept in the test tube while all the solution removed and tested on an ICP OES to determine the adsorption of lithium on the treated media liquid sample (“Treated” media sample in Table 3C).

A 50 mL batch adsorbent test to evaluate fouled media treatment was performed by placing 10 g of untreated commercial fouled media in a 50 mL test tube. 40 mL of standard feed brine was added to the test tube. The standard feed brine contained ˜110 ppm lithium, 725 ppm magnesium, 1635 ppm calcium and 41000 ppm sodium. The test tube was capped and placed on an orbital mixer for 4 hours. After mixing the liquid was decanted, the media was kept in the test tube while all the solution removed and tested on an ICP OES to determine the adsorption of lithium on the untreated media liquid sample (“Untreated” media sample in Table 3C).

A 50 mL batch adsorbent test to evaluate fouled media treatment was performed by placing 10 g of clean, conditioned media in a 50 mL test tube. 40 mL of standard feed brine was added to the test tube. The standard feed brine contained ˜110 ppm lithium, 725 ppm magnesium, 1635 ppm calcium and 41000 ppm sodium. The test tube was capped and placed on an orbital mixer for 4 hours. After mixing the liquid was decanted, the cleaned conditioned media was kept in the test tube while all the solution removed and tested on an ICP OES to determine the adsorption of lithium on the cleaned, conditioned media liquid sample (“Clean, conditioned” media sample in Table 3C).

TABLE 3C

| | Al | Fe | Li | Mg | Na | Ca |
|---|---|---|---|---|---|---|
| Media sample | (ppm) | (ppm) | (ppm) | (ppm) | (ppm) | (ppm) |
| Treated (0.001M 2 Na | 0.53 | 0.67 | 13.69 | 555.2 | 24579 | 1129.4 |
| EDTA loaded) | | | | | | |
| Treated (0.001M 4 Na | 1.12 | 2.87 | 14.78 | 558.11 | 25031 | 1127.7 |
| EDTA loaded) | | | | | | |
| Treated (0.001M 2 DTPA | 0.63 | 4.20 | 13.68 | 567.68 | 24684 | 1133.2 |
| loaded) | | | | | | |
| Untreated (fouled media | 0.65 | 0.16 | 36.89 | 650.07 | 28850 | 1309.8 |
| blank eluted) | | | | | | |
| Clean, conditioned | 0.82 | 0.02 | 14.95 | 648.58 | 28643 | 1306.6 |
| (conditioned media eluted) | | | | | | |

As shown in Table 3C, the loading concentration of lithium after batch treating commercially fouled media multiple times (treated media liquid sample) greatly improves when compared to the untreated fouled media and begins to match the loading of the conditioned, clean sorption media. The similar Mg, Na, and Ca support that the brine feeds were similar.

1. A method for treating an aqueous lithium salt-containing solution in a direct lithium extraction process comprising lithium-selective media, wherein the aqueous lithium salt-containing solution comprises one or more foulants, the method comprising:
a) adjusting an oxidative-reductive potential and/or pH of the aqueous lithium salt-containing solution to render the one or more foulants inert to the lithium-selective media; and
b) removing the one or more inert foulants from the aqueous lithium salt-containing solution prior to addition of the aqueous lithium salt-containing solution to the lithium-selective media in a direct lithium extraction process.

2. The method according to claim 1, wherein the aqueous lithium salt-containing solution is a naturally occurring solution, a leachate, a synthetic solution or a mixture thereof.

3. The method according to claim 1, wherein the lithium-selective media is ion-exchange media or lithium-adsorbent media.

4. The method according to claim 1, wherein the one or more foulants is of an inorganic, organic, organometallic, ionic or elemental nature.

5. The method according to claim 4, wherein the one or more foulants comprises any of silica, iron, strontium, calcium, magnesium, sodium, calcium, boron, chloride, sulfate and carbonate.

6. The method according to claim 1, wherein adjusting the oxidative-reductive potential and/or the pH of the aqueous lithium salt-containing solution to render the one or more foulants inert comprises increasing the oxidative-reductive potential by air sparging, addition of an oxidant or an electro-chemical modification.

7. The method according to claim 6, wherein the oxidant comprises hydrogen peroxide, ozone, sodium hypochlorite, potassium monopersulfate, hypochlorous acid, or a hydroxy radical.

8. The method according to claim 1, wherein adjusting the oxidative-reductive potential and/or the pH of the aqueous lithium salt-containing solution to render the one or more foulants inert comprises decreasing the oxidative-reductive potential by addition of formic acid or metal hydride.

9. The method according to claim 1, wherein adjusting the oxidative-reductive potential and/or the pH of the aqueous lithium salt-containing solution to render the one or more foulants inert comprises precipitating or decomposing the one or more foulants.

10. The method according to claim 1, wherein removing the one or more inert foulants from the aqueous lithium salt-containing solution prior to addition of the aqueous lithium salt-containing solution to the lithium-selective media in a direct lithium extraction process comprises filtrating the one or more inert foulants.

11. The method according to claim 10, wherein filtrating the one or more inert foulants comprises using magnetism, membrane separation, a multi-media filter, a coalescing filter, decanting, and/or a guard bed.

12. The method according to claim 1, further comprising an initial step preceding step a) of monitoring the oxidative-reductive potential and/or pH of the aqueous lithium salt-containing solution.

13. The method according to claim 1, further comprising an additional initial step preceding step a) of passing the aqueous lithium salt-containing solution through a guard bed.

14. The method according to claim 13, wherein the guard bed comprises an adsorbent material capable of adsorption of any unwanted foulant whilst allowing lithium salt to pass through.

15. The method according to claim 14, wherein the adsorbent material in the guard bed is an ion exchange resin, a metal oxide or a zeolite, in any of a granular composition, a powder, or a slurry.

16. The method according to claim 14, further comprising fluidizing the lithium-selective media and/or the adsorbent material in the guard bed.

17. The method according to claim 1, further comprising adding a chelating agent to the lithium-selective media, wherein the chelating agent is capable of binding to any of the one or more foulants.

18. The method according to claim 17, wherein the chelating agent comprises ethylenediaminetetraacetic acid (EDTA), citric acid, oxalic acid, or acetic acid.

19. The method according to claim 17, wherein the chelating agent is subsequently removed from the lithium-selective media by filtering, rejection or fluidization.

20. A method for improving operability of a direct lithium extraction system comprising lithium-selective media, the method comprising:
(a) flowing an aqueous lithium salt-containing solution having one or more foulants through the lithium-selective media to remove lithium chloride from the aqueous lithium salt-containing solution;
(b) flowing a desorbent fluid through the lithium-selective media to desorb lithium chloride to produce an eluate stream comprising lithium chloride;
(c) recovering a lithium product stream from the eluate stream; and
(d) operating a procedure for removing at least one of the one or more foulants from the lithium-selective media with a chelating agent capable of binding to the one or more foulants.

21. The method according to claim 20, wherein the chelating agent comprises ethylenediaminetetraacetic acid (EDTA), citric acid, oxalic acid, or acetic acid.

22. The method according to claim 20, further comprising, after step (d) in which the chelating agent binds to the one or more foulants, removing the chelating agent from the direct lithium extraction system by filtering, rejection, or fluidization.

23. The method according to claim 20, further comprising flowing the aqueous lithium salt-containing solution through a guard bed prior to flowing the aqueous lithium salt-containing solution through the lithium-selective media.
